(19) United States
(12) Patent Application Publication
(10) Pub. No.: US 2001/0044735 A1
(43) Pub. Date: Nov. 22, 2001

(54) Auditing and monitoring system for workers' compensation claims

(76) Inventors: Harry S. Colburn, Bloomfield Hills, MI (US); Pamela Haron, Farmington Hills, MI (US); Anne L. Loverde, Harrison Township, MI (US)

Correspondence Address: HARNESS, DICKEY & PIERCE, PLC, P.O. BOX 828, BLOOMFIELD HILLS, MI, 48303, US

(21) Appl. No.: 09/844,102

(22) Filed: Apr. 27, 2001

Related U.S. Application Data
(60) Provisional application No. 60/201,075, filed on Apr. 27, 2000.

(51) Int. Cl. G06F 17/60

(52) U.S. Cl. 705/4

(57) ABSTRACT

A system for optimizing a workers' compensation claims management process, which contains files relating to a workers' compensation claim of an injured individual is disclosed. The current workers' compensation claims management process is reviewed to determine if best practices are being followed. If the best practices are not being followed, the system implements them. The system further monitors the amended workers' compensation claims management process to determine if the best practices are being followed; and, will closely monitoring specific cases within the workers' compensation claims management process to determine if the best practices are not being followed.

### CROSS-REFERENCE TO RELATED APPLICATIONS

This application is a continuation-in-part of U.S. Provisional Application No. 60/201,075, filed on Apr. 27, 2000, the disclosure of which is incorporated herein by reference.

### BACKGROUND OF THE INVENTION

This invention relates generally to an insurance auditing and monitoring system, and more particularly to a system for auditing and monitoring workers' compensation claims.

Workers' compensation claims result in significant costs to employers of any size. Normally, workers' compensation claims are handled by third party administrator (TPA) adjusters in the case of self-insured employers, or by adjusters employed by a primary insurer. In either case, a prolonged recovery of an injured worker leads to significant costs in the form of increased claims expense and/or premiums to employers. It is not difficult for some claims to fall by the wayside, because claim adjusters' caseloads can average 175-250 lost time claims. These heavy burdens promote the off-loading of claims management responsibilities to legal counsel/medical case managers or other vendors who may not be held accountable for their results.

Under certain circumstances, the TPA adjusters, as well as the claim adjusters for insurance companies, may be subject to internal audits, which are conducted to check a claim file to determine if internal performance standards are bring met or to determine that proper amounts of funds (reserves) are allocated for claims. These internal audits are not directed toward reducing the recovery time and subsequent return to work of a particular injured employee, thus not necessarily impacting the direct or indirect costs of a particular claim to employers.

### SUMMARY OF THE INVENTION

In accordance with the teaching of the present invention, an independent third party auditing and claim monitoring system is disclosed. The system begins with an evaluation of the current status of an employer's total workers' compensation program. The system evaluates the current agreement between an insurer or TPA and the employer for claims management techniques, epic service specifications and required interaction between the two parties. After evaluation, modifications to the agreement are suggested to incorporate best practices and measurable goals into the existing agreement between the employer and the insurance service provider. These best practices and measurable goals provide the foundation by which the system evaluates the performance of the assigned adjusters, thus enhancing their performance level which ultimately creates a reduction in costs for the employer by decreasing direct and indirect costs.

Further, the system provides a methodology whereby the employer's return to work policy or plan is evaluated. In the situations where the return to work policy or plan does not exist, the system assists in the implementation of such a plan. Where the return to work policy or plan exists, the plan is evaluated and return to work best practices and policies are recommended.

The system then establishes an initial benchmark or goal for each claim. This allows the employers to gain a better understanding of the long-term potential liability for a particular case. In situations where it appears there is a high probability that the employers will encounter significant costs, a proposed initial assessment is provided given the preliminary circumstances.

In addition to monitoring current claims, the system utilizes a methodology to monitor new claims. This methodology offers an Initial Recommendations Report to the employers within 72 hours of the initial claim report. Through this report, employers know up front the scope of the claim and its projected resolution. In this initial report, the system helps identify high risk claimants. The early identification positively impacts the ultimate cost of claims. An aggressive approach to workers' compensation claims helps put the employee back to work and saves employers money and resources.

### BRIEF DESCRIPTION OF THE DRAWINGS

The present invention will become more fully understood from the detailed description and the accompanying drawings, wherein:

FIG. 1 is a flowchart describing the analysis of a current insurance carrier system; and

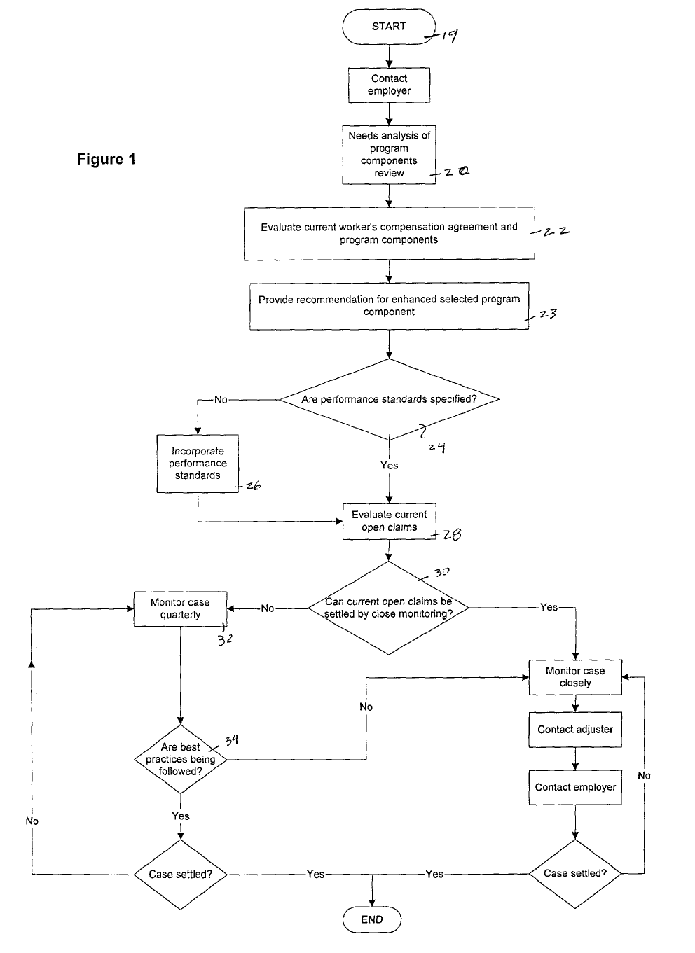

FIG. 2 is a flowchart describing the handling of new insurance claims.

### DETAILED DESCRIPTION OF THE PREFERRED METHODOLOGIES

The system disclosed herein continually monitors open claims on the employer's behalf, making sure that the claims adjuster is following aggressive claims management techniques. The system sees that nothing slips through the cracks. By providing quarterly statistics that summarize the systems continual monitoring, the system gives an employers an in-depth recap of its findings—a solution that has not been provided until now.

The system also audits closed or stagnant open claims to determine inefficient claims handling procedures. Once audited, stagnant claims can be monitored toward a desirable cost effective resolution through application of extended recommendations.

The system begins with an initial evaluation of an employer's workers' compensation program. The agreements between the employers and an insurance carrier or, in the case of self insured employers, the TPA are reviewed. These agreements are reviewed to determine whether specific practices by the adjuster for the monitoring of a claim are spelled out. If specific practices are not spelled out, best practices (explained further below) will be incorporated into the agreement and presented to the insurance carrier or TPA. If best practices are not being applied by the adjuster, they are incorporated into the agreement between the parties.

The system does an evaluation of an employer's previous workers' compensation claims to determine if there are any changes which must be made in the employer's facilities, for example ergonomic considerations in a plant. Recommendations for changes in an employer's processes based on an evaluation of previous problems are made. These may include but are not limited to training of employees in courses such as lifting workshops or may include changes to the hardware used in the work setting.

During the evaluation of previous workers' compensation claims, a determination is made as to what are the most significant and most likely hidden and direct costs of an employer's current workers' compensation claims. A program for addressing and reducing these costs is developed and recommended. Any current workers' compensation claims are strictly monitored to bring them into a position where they can most easily be resolved and the employee returned to the workplace. This includes assuring that the employee gets any necessary medical treatment.

The system includes proactively reviewing all newly reported claims within 72 hours for determining whether they represent a high risk potential. Further, the system envisions moving open stagnant claims off center toward a desirable cost-effective resolution. This is done by interacting with insurance carriers and TPA's in monitoring the status of open claims. The system also encompasses reviewing initial claim investigations for thoroughness.

The system promotes the development and follow up of proactive and aggressive action plans, which should mirror the set of “best practices” for claims adjusters. Further, the system provides that claim activities show a clear focus, allowing an employee to return to work as soon as possible.

The system provides for a review of current program components and does a benchmark analysis based on historical statistical data. An action plan is developed for the overall program that can include a performance guarantee agreement, light duty return to work programs, behavior modification, etc. The system addresses problems within insurance carriers which cost employers money. The operating practices of insurance carriers and TPA's often vary, but the problems addressed by the system are often the same throughout the industry.

Employers purchasing workers' compensation programs do not understand the effects of a claim's hidden costs. So what employers thought was a bargain either in claims handling fees or in premium turns out costing them more money than it should. Whether employers are self-insured or have a guaranteed cost program, hidden costs can erode their bottom line.

The system begins with an initial evaluation of the employer's workers' compensation program in process block 18. Then, in process block 20, the system reviews the agreements between the employers and an insurance carrier or, in the case of self-insured employers, the TPA. In query block 24, these agreements are reviewed to determine whether specific practices by the adjuster for the management of a claim are spelled out. As an example, the agreement is evaluated to determine if it includes performance guarantees. If it does not, the system assists in the formation of an agreement incorporating them. If specific practices are not spelled out, best practices will be incorporated into the agreement in process block 26 and presented to the insurance carrier or TPA. If the adjuster is not applying best practices, these practices are then incorporated into the agreement and subsequently monitored.

In process block 28, the system performs an analysis of an employer's previous workers' compensation claims to determine if there are any areas within the employer's facilities that may be developing significant exposures; for example, ergonomic considerations in a plant. Recommendations are then offered to make changes in an employer's processes or facilities based on the evaluation of previous problems. These may include arranging for training of employees in courses such as lifting workshops or may include suggesting changes to the hardware used in the work setting.

In query block 30, the system determines whether current open claims can be settled by close monitoring. If the current claims cannot be settled by close monitoring, the system monitors the claim in process block 32 quarterly to determine as suggested in query block 34 whether best practices are being followed. Should the system determine in query block 34 that the best practices are not being followed, the case is monitored closely in process block 36. This includes contacting the adjuster in process block 37 and the employer in process block 38 to ensure that the insurance carrier or TPA reinstitute best practices.

Should the system determine in query block 30 that the current open claims can be settled by close monitoring, the system institutes the monitoring of the case closely in process block 36. The adjuster and employer are contacted in process blocks 37 and 38 respectively. The initial evaluation of an employer's workers' compensation system ends at block 39.

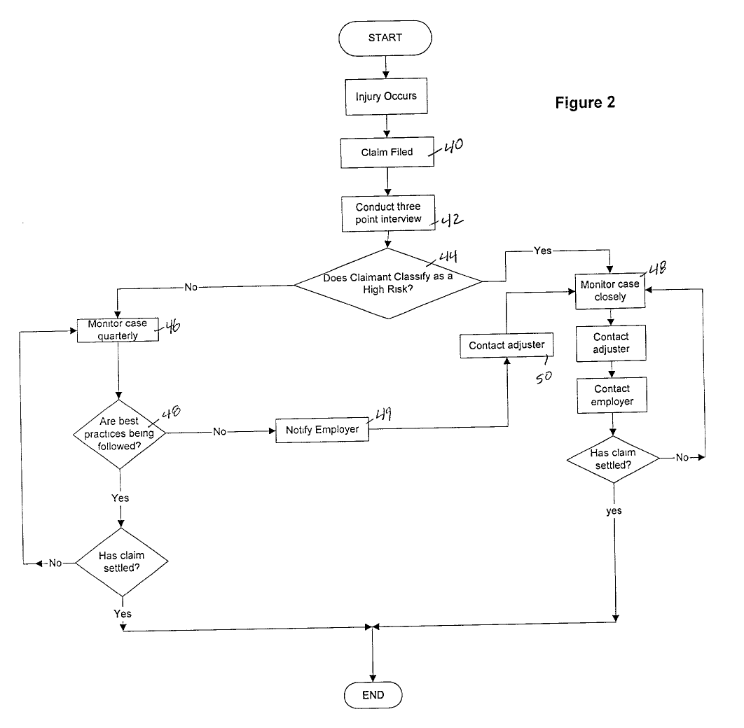

As best seen in FIG. 2, the system includes proactively reviewing all new employers claims within 72 hours for determining whether it represents a high risk potential. By quickly addressing the claims within this short amount of time, it has been found that the percentage of claims labeled as high risk and leading to long term, high cost claims can be significantly reduced. Aggressively monitoring these claims in their early stages encourages proper medical attention and treatment and the proper therapies to be applied in a timely manner.

Critical to the proper implementation of the insurance monitoring system, is a proper file handling and investigation. As part of the evaluation of best practices, the system in process block 40 monitors whether the TPA or insurance acknowledges the receipt of the workers' compensation report within 24 hours. In process block 42, the system further determines whether the proper initial contacts are made. That is, whether the employee, employer and medical treater has been contacted within 24 hours from the date of receipt of the claim. The adjuster must determine the compensability of the claim within 72 from the date of acknowledgment. Furthermore, the adjuster must perform a thorough investigation including recording statements by the injured employee and witness statements. The adjuster must have conducted a review of the claim to determine if there are possible subrogation or second insurance funds who may cover the underlying injuries.

The system takes these steps through an extensive interview process with a registered nurse. The nurse assesses the potential of a high cost injury and then develops the Initial Recommendations Report including cost projections. Employers are provided with the Initial Recommendations Report and will now have information about the initial scope of the claim and can plan accordingly. The report outlines recommendations, treatment and cost projections and possible complications, including a three-point contact summary outlining initial information obtained from the employee, employers and medical treatment provider; will include the diagnosis combined with identified red flags.

In query block 44, the system determines whether a claimant is classified as a high risk. Several factors are evaluated in determining whether a claimant is high risk and depend upon the answers to the following questions by the injured employee, the employer, and the treating medical personnel:

Basic Questions Asked the Injured Employee:

Education level; job title; job description; date of injury; date reported to supervisor/employers; ask questions about the incident that caused the injury, What happened?, When?, How?, Where?, Anyone else involved?; Anyone witness the incident?; Describe your injury(ies); Do you think you could have prevented the incident from happening?; What medical treatment did you receive?, by Who?, When; When is your next appointment?; Do you have any physical restrictions?; Are you currently taking any type of medication? If yes, What?; Did you ever have any problems with your body part before? If yes—try to find out What?, How?, When?; Have you ever had any other work related injuries?; How are you feeling now?; Are you comfortable with your primary medical provider?; Do you have any allergies?; Have you ever had any surgeries, serious illness?, What?, When?, Why?; Do you consider yourself to be normally healthy?; How are your eating habits?; Do you have any hobbies?; What do you do for recreation?; Do you smoke? How long?, How much?; Do you drink? How much?; Do you get along well with the people at work?; Are you looking forward to returning to work?; Do you have any questions or concerns regarding your claim?.

Basic Questions Asked the Employer:

Record name of person you are talking with, date and time; Employees name Date of hire; Job title; Job description, including responsibilities and physical requirements; Home address, telephone number; Description of injury Was employee sent directly to primary medical provider? If yes, Who?

Results of primary medical provider^{L}_{F} evaluation:

Diagnosis

Restrictions, if known, treatment plan

Prognosis

Is employee currently back to work? What job?; If employee is not working, Why not? Restrictions unable to be met?; What type of employee has he/she been during the past?; Attitude/relationship with supervisor, management, co-workers? Attendance pattern; Any recent disciplinary problems?, If yes, What?

Basic Questions Asked Primary Medical Provider:

When did you first see employee?

Diagnosis?

Prognosis?

What is your current treatment plan for Employee?

When did you last see employee?

Considering the description of the accident/incident of _, do you believe the medical condition is the result of the incident?

Do you think we need to get a specialist involved?

Please send me a copy of employee's medical records

Recommendations—depending on the type of injury, recommendations may include the need for further medical evaluations, involvement of specialists, physical restrictions, modified work plan, etc., as appropriate.

The system identifies the projected costs based on outlined recommendation, time projections specifying expected recovery period, and additional costs/recommendations depending on anticipated medical treatments. Possible complications are evaluated and an outline of possible impact of ancillary medical conditions or other issues that may negatively impact recovery from the work-related injury/illness is made.

Upon completion of the interview process on a particular claim, the registered nurse will review the documented responses of the employer, employee, and treating medical care provider. Such review enables the registered nurse to observe the described incident, alleged injury, diagnosis, prognosis, employment status, information relative to the employee's emotional and motivational status and attitude about his work environment and current medical condition. Responses to leading questions posed in conjunction with the employee's offered ancillary information provides the registered nurse with insight into possible complications and the employee's motivational level. During the review, the nurse assigns either a “positive” or “negative” make by each item deemed to be important to the case's disposition.

Positive Responses—responses that would not create an adverse effect on the individual's medical condition and ability to regain physical attributes and return to work within the prescribed length of disability, if applicable. Negative Responses—responses and/or comments that would adversely effect the individual's medical condition and ability to regain physical attributes and return to work within the prescribed length of disability, if applicable.

Based upon the responses, the system in query block 44 determines if the claimant has a high risk factor of being a problem claim. The system using the following criterion:

High Risk Factor Calculation:

Total Positive Marks =
Total Negative Marks = +
Total Assigned Marks =

Divide Total Negative Marks by Total Assigned Marks =

High Risk Factor

| | |
|---|---|
| High Risk Factor % | Risk Level |
| 0-30% | Low Risk |
| 31-45% | Medium Risk |
| 46-65% | Medium High Risk |
| 66-100% | High Risk |

It is envisioned this evaluation can be conducted on a computer.

Within 72 hours from receipt of the report of injury/illness, the High Risk Claim Report will be shared with the employer's designated representative and the assigned claims adjuster. An employers comp advocate's auditor/monitor will converse with an assigned claims adjuster to ensure that information presented within the report becomes incorporated within the claim's plan of action. Future monitoring activities will confirm progression of claim toward resolution.

If an initial determination shows a claimant is considered high risk, aggressive monitoring procedures are followed in process block 48. Under normal workers' compensation claims management processes, third party auditing of the claim is never done early in the life of the claim. Further, it is not difficult for some claims to fall by the wayside, because claim adjusters' caseloads can average 175-250 lost time claims. These heavy burdens promote the off-loading of claims management responsibilities to legal counsel/medical case managers or other vendors who may not be held accountable for their results. This results in high risk claims requiring significant amounts of additional funds and resources before they are resolved or settled.

The system regularly monitors at process block 46 and 48 the claim at regular intervals to determine whether best practices are being followed by the TPA or insurance carrier, as well as by the medical professionals. If the system in query block 48 determines that best practices are not being followed, the employer is notified in process block 49 and the adjuster is notified in process block 50 that the case will be monitored closely (process block 48).

Many factors are reviewed in process block 48 in determining if best practices are being followed. For example, within 14 days of the report, or otherwise as determined by state law, the TPA must determine whether a first payment should be made from the evidence in the file, as 14 days is the time when a determination of whether the insurer is going to contest the responsibility of the case.

In monitoring whether best practices are being followed and performance guarantees are being met (process block 48), the system then determines whether there is a thorough knowledge and thought process with respect to the file notes and an action plan. An action plan must incorporate all the known facts of the case, and indicate specific follow-up dates. Furthermore, the file must note an ordering of a report which would give information if the employee has ever filed a workers' compensation claim within the United States in the past, within 48 hours of the date of the date of the receipt of the report. Files must be maintained in a neat chronological order and must contain all pertinent documentation.

The system further reviews in process block 48 the reserves for this particular claim. An accurate initial reserve must be set based on an adjuster's rational and thought process. Within 5 days from the date of accident, the initial reserve must be established. This report must include all known facts. Within 45 days from the date of the accident, the reserves must be reviewed and adjusted based upon additional known facts. At the time of the review of the file, the reserves should reflect an “expected value” based on the known facts. All reserve changes must be properly documented within the file and reserve history. Reserve changes must be explained in detail to provide an accurate timely basis of value. Reserves must not deviate more than 10% of the reserve value at 12 months. It must have a sound rational. A complete reserve analysis worksheet must be part of the computer file notes and paper file.

In addition to checking on file handling and reserve procedures, the system further provides medical management. The system determines in process block 48 whether reports are properly housed and noted within a computer file. It further determines whether this medical information is updated within every 30 days. Any adjustment must demonstrate a strong evaluation of the medical information including follow-up with the medical personnel and employer and employee. Timely re-contacts of the employee, employer, and medical provider must be properly documented. Timely exploration of light duty return to work must be properly documented and followed up as required. The system insures the timely development and execution of a return to work plan is performed and properly documented. The timeliness and appropriateness of assignment must be properly documented within the file notes. The adjuster must provide direction and expectations to the vendor to control the vendor activities. The adjuster must continually follow-up on vendor activities to determine the results of all the activities.

The system further determines in process block 48 whether a rehabilitation management plan has been completed and whether it is being implemented in a timely and appropriate fashion. The adjuster must provide direction and expectations to the vendor to control the vendor activities. Furthermore, the adjuster must continually follow-up on vendor action plan to determine if the vendor is following the vendor's plan.

The system in process block 48 also optionally monitors and tracks litigation. The system determine whether a legal counsel has been timely and appropriately assigned. This information must be properly documented within the file notes. The adjuster must prepare a summarization for legal counsel and provide a carbon copy for all documentation retained in the carbon copy file. The adjuster is responsible for demonstrating timeliness of transfer of information to the legal entities including updates of medical information. The adjuster must continually follow-up in the disposition of the case to mitigate expenses wherever possible.

With respect to case management, the system in process block 48 determines whether the TPA has filed notes to reflect follow-up activities with regard to the actual plan column modifications as explained. The file notes must reflect the follow-up activities regarding re-contacts with the employer, employees, and medical professionals as well as vendors. When necessary, the system determines whether surveillance has been timely ordered and expenses controlled. Further, all notes must be reflected within the file. The adjusters must continually follow-up with claimant and vendor's activities to mitigate expenses at all times. The file notes must reflect key issues, result, and disposition as they occur.

Most importantly, the system will determine whether properly reporting has occurred. The file notes must be timely and accurate to reflect the files current status. All required State forms must be prepared and filed on a timely basis. Furthermore, all interaction with risk management must be documented and performed timely. The supervisor reports must be made part of the claim file, notes, and paper file according to schedule. The adjuster must also provide risk management with the status update and negotiation plans accurately and timely as scheduled. The report to see if the employee has ever filed a workers' compensation claim in the United States must be ordered and properly documented every 6 months.

The system in process block 48 also determines whether the case management has proper supervision. Normally, this begins when a determination of initial direction is made. The supervisor file notes must reflect direction and evidence of involvement with the adjuster. Furthermore, a supervisor outline, which identifies key issues and resolution during the reviews, must be shown. An adjuster's supervisor must illustrate review of the case reserve and to their adequacy, and must reflect the timely review; that is, at 30, 60, and 90 days. The supervisor must ultimately be responsible for the adjuster's case and expense control.

The system offers a unique marketing opportunity for insurance agencies. The marketing strategies are designed to specifically help insurance agent retain existing accounts as well as develop new business.

The system becomes an extension of an insurance agency's risk management department efforts. As their “back room” for auditing and monitoring claims, agents can offer these unique services to both their clients and prospects either as value added services or for an additional fee.

The marketing strategy uses the system to allow insurance agents to offer services that they are currently not able to provide. Agents can tell prospects as well as their own clients that they have a system to help reduce their workers' compensation costs. The agent now has a better tool to show his client/prospect that he has a unique system that allows his agency to distinguish itself from others. The agent can then discuss such system components as the analysis of an employer's workers' compensation program, identification of potentially high risk claims, auditing/monitoring workers' compensation claims and other components offered by the system. The agent will have the opportunity to spend time “educating” clients/prospects on direct and indirect hidden costs and their impact on the client's/prospect's bottom line.

The marketing strategy is now not contingent on expiration dates or even writing insurance coverage. It assists the agent in becoming an educator, not just a salesperson. Just as this strategy applies to the relationship between agents and their prospects/clients, it also applies to the relationship between wholesalers and retail agents.

### UNCONTROLLED DIRECT HIDDEN COSTS

Many workers' compensation claims handled without the system continue to suffer from direct hidden costs—unnecessary expenses from services or procedures that don't produce the correct results or are deemed inappropriate.

Employers often won't hear about direct hidden costs because employer's insurance carrier/TPA thinks about these expenditures as their cost of doing business. These areas are, more times than not, found within the claim's allocated expenses.

Uncontrolled Direct Hidden Costs are the Result of:

Lack of thorough initial investigations

Lack of follow-through in claims actions plans

Increase in off-loading responsibility to vendors

Unnecessary litigation expenses

Inaccurate claim payments

Inexperienced claims and loss control personnel

The system provides a methodology for significantly reducing the uncontrolled direct hidden costs by insuring that the best method for a speedy recovery of the employee occurs. Proper case oversight and management insures that an injured employee will receive the proper medical attention and impetuous to return to work.

Employers think they are done after they have paid premiums or TPA claim fees. But, hidden costs impact the employer's bottom line whether handled by an insurance carrier or TPA. Uncontrolled indirect hidden costs are the result of: time lost by supervisors; paying replacement workers; decreased employee morale and efficiency; overhead costs while work is disrupted; and loss of expertise or production by trained worker.

An example of the use of the system is as follows:

The injury: Metal shavings caused injury to an employee's thumb.

The claim should have closed within two months but continued six more months due to inefficient claims handling.

The extended claim duration generated $11,231.52 in unnecessary lost time payments and expenses.

The total claim payment was $39,231.69

Like the uncontrolled direct hidden costs, the system is designed to reduce the uncontrolled indirect hidden costs. By reducing the time the injured worker is off the job, the uncontrolled indirect hidden costs are also significantly decreased.

The system will monitor for each case or a statistically significant number of cases. Each of the aforementioned ratios determine whether a TPA/insurance provider following best practices. A report is provided to the employer as to which cases or adjusters are not meeting required expectations or criteria. A ranking is given to a particular TPA or adjuster to indicate the level of compliance with the required contractual services. The report is often forwarded to the insurance carrier or a TPA to allow them to respond to the employer directly. This allows the employer, the employee, and a third party auditor to meet and discuss the performance of the workers' compensation claim system and determine ways to reduce the indirect and direct hidden costs.

In the following case study, the system shows “what should have been” on a closed claim. Ongoing monitoring of a new or open stagnant claim allows the system to be employer's second set of eyes. It allows us to ensure efficient and cost effective claims handling by the insurance carrier/TPA claims adjusters. The following case study is viewed by the claim adjuster and by the system:

### Claim Adjuster's View

On Apr. 19, 1999, a 41-year-old man reported an injury to his thumb from metal shavings penetrating his glove on March 31st while working as an assembler. The adjuster's initial three-point contact (employee, employers, and medical provider) was completed on April 23rd. With antibiotic treatment, the recovery period was expected to be 2-3 weeks. Follow-up medical treatment with the carrier's primary care provider showed complications, extending the disability an additional 3-4 weeks. Employer was unable to accommodate “light duty” return to work.

Upon advisement of medical complications, the adjuster assigned both a telephonic case manager and medical case manager at the end of April. During May, claimant underwent physical therapy. Mid May, claimant advised the adjuster that his own physician noted slow progress; and, therefore, was continuing the initial medical restrictions.

At the end of May, the adjuster ordered an Independent Medical Examination (IME) and surveillance upon hearing from claimant's supervisor that claimant was involved in home-improvement projects using his disabled hand/thumb. Even though two separate days of surveillance tapes confirmed rigorous use of disabled hand/thumb, the IME report maintained existing medical restrictions. Claimant continued to receive disability payments and periodically saw his own physician until Dec. 20, 1999, when he received a full release to return to work without restrictions.

### The Systems View

The case study helps illustrate the typical findings of a system audit where inefficient claim handling created a projected 28.63% increase in the incurred claim amount. In processing this claim, the system would have implemented procedures to reduce costs.

Initial report completed by the system. The system would have made the following observations:

March 31^{st}—Metal shavings caused injury to employee's thumb

April 19^{th}—Employee reported injury to employers

April 20^{th}—Employers reported injury to carrier

Analysis by the system shows the treatment plan is questionable.

On April 23^{rd}—The system would have made the following observations:

three-point contact completed by adjuster

Clinic treated thumb—two/three weeks anticipated duration of disability

three-point contact completed by adjuster

Clinic treated thumb—2-3 weeks anticipated duration of disability

Indemnity payments began $372/week

Why was adjuster's 3- point contact late?

Why late reporting by employee?

Should claim have been disputed?

No witness statements

No outlined action plan

No follow up with supervisor about gloves—Worn? Adequate?

The system Initial Recommendations Report would have been distributed to employers and adjuster outlining projected treatment, recommendations and anticipated duration of disability

On May 10^{th}-31^{st}—The system would have made the following observations:

Medical follow-up exam: complications projected 3-4 weeks more disability

Adjuster assigns telephonic & medical case managers

Physical therapy bills paid: $1,456.94

Why off-loading to telephonic and medical case managers needed?

File notes sketchy regarding progress and status

No Physical Therapy Evaluation and status reports

Who approved?

Why ordered?

No notes regarding its progression/success

No notes on revisiting “light duty” return to work

On May 20^{th}—The system would have made the following observations:

Claimant sees personal physician who recommends continued disability and medical restrictions

Technician orders an Independent Medical Examination (IME) and surveillance based on rumors from co-workers that claimant was okay

Surveillance cost—$2,156.68

Good proactive measure

The system determines that there is a lack of follow-through on the part of the adjuster:

On June 24^{th}—IME maintained current medical restrictions

Surveillance tapes confirmed rumor of numerous rigorous activities using “hand/thumb”

Periodic office visits with personal physician continued disability

Why did it take so long to get IME report?

Clarification of IME report needed regarding vague contents and conclusions

Why weren't results of surveillance shared with telephonic and medical case managers, IME physician, employers, or claimant

Why was surveillance done if not used?

File notes continued to be sporadic and sketchy

Claim should have closed with no further indemnity payments

On December 20^{th}—The system made the following observations:

Claimant's physician gave full release with no medical restrictions

Claim should have been closed back in June subsequent to IME

File notes continued to be sketchy and lacked content

Random periodic contact by adjuster with claimant

The system concluded that a claim that should have been closed within 2 months continued unnecessarily for an additional 6 months. Total hidden costs of $11,231.52 found in:

$3,867.63—unnecessary assignment of case workers

$1,456.94—physical therapy; lacked evaluation, status reports, evidence of approval

$2,156.68—surveillance/IME—should have been used to close claim

$3,750.27—over 10 weeks unnecessary additional indemnity payments

Total projected hidden costs are conservative and do not reflect indirect hidden costs the employers incurred. The 28% in direct hidden costs was representative of all claims reviewed in this employer's audit where total average incurred claims for 3 years was $978,362.00, resulting in projected annual direct hidden costs of $273,941.00.

The Impact on One Claim:

Twenty-eight percent in unnecessary claim costs was found by the system.

The Impact on the Employers Entire Workers° Compensation Program:

The 28% in unnecessary claim costs also represented the averaged three year claim period reviewed by the system in this employer's audit. And, of course, this percentage does not account for uncontrolled indirect hidden costs.

As seen in this case study, the system can show “what should have been” on a closed claim. Ongoing monitoring of new or open stagnant claims allow the system to be the employer's second set of eyes to ensure efficient and cost effective claims handling by the insurance carrier/TPA claims adjusters.

The system assists employers in determining where and how employers' workers' compensation claim dollars are being spent or allocated. How many “medical only” and “lost time claims” is an employer's claims adjuster assigned to and responsible for on a month-to-month basis? Is the employer paying on non-compensable claims due to poor initial investigations? Are employees receiving the appropriate medical treatment to quicken their recovery and return to work? How are employee case reserves being established? Are they step reserved, worse case scenario, or most likely/expected? Are medical case management and vocational rehab managers being improperly used or used as an “off-load” by overworked claims adjusters? Additionally, the system will provide an employer with methods to measure the results derived from an employer's monitoring process. The system can establish a benchmark developed by reviewing employer's old claims and measure that against the results the system obtain from the system auditing process on employer's new claims. The system further allows the employer to measure how insurance carriers/TPA's react to employer's involvement. Employers able to monitor claims throughout the U.S. and allow employer's claims reviewed by the system for an objective viewpoint. The system functions as the employer's second set of eyes. While employers may be advised by employer's carrier/TPA of the steps taken with regard to a claim, employers probably won't hear about the inefficiencies in claim handling.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of optimizing a workers' compensation claims management process, which contains files relating to a workers' compensation claim of an injured or ill individual comprising the steps of:
reviewing the workers' compensation claims management process to determine if best practices are being followed; and
amending the workers' compensation claims management process by implementing the best practices into the workers' compensation claims management process.

2. The method of claim 1 further including the steps of:
monitoring the amended workers' compensation claims management process to determine if the best practices are being followed; and
closely monitoring a specific case within the workers' compensation claims management process to determine if the best practices are not being followed.

3. The method of claim 1 wherein the best practices are selected from the group consisting of: within 14 days of a claim initiation determine whether a first payment should be made from the evidence in the file, determine whether there is a thorough knowledge and thought process with respect to file notes and an action plan with the file, ordering of a report which would give information if the employee has ever filed a workers' compensation claim within the United States in the past within 48 hours of the date of a report of an accident, set within 5 days from the date of accident the initial reserve, the file is maintained in a neat chronological order, the file contains all pertinent documentation, report must include all known facts, within 45 days from the date of the accident the reserves must be reviewed and adjusted based upon additional known facts, at the time of the review of the file the reserves should reflect an expected value based on the known facts or combinations thereof.

4. The method of claim 1 wherein the best practices are selected from the group consisting of: reserve changes must be properly documented within the file and reserve history, reserve changes must be explained in detail to provide an accurate timely basis of value, reserves must not deviate more than 10% of the reserve value at 12 months, a complete reserve analysis worksheet must be part of the computer file notes and paper file or combinations thereof.

5. The method of claim 1 wherein the best practices are selected from the group consisting of: determining whether a report is properly housed and noted within a computer file, determining whether medical information is updated within 30 days, determining if any adjustment to a treatment plan must demonstrates a strong evaluation of the medical information including follow-up with the medical personnel and employer and employee, timely re-contacting of the employee employer and medical provider, timely exploration of light duty return to work must be properly documented, the timely development and execution of a return to work plan is performed and properly documented, timely and appropriate assignment of light duty work, or combinations thereof.

6. A method of optimizing a workers' compensation claims management process, which contains files relating to a workers' compensation claim of an injured individual comprising the steps of:
conducting a three point interview within 72 hours of an injury;
determining whether a claim and is classified as a high risk; and
monitoring a claim at periodic intervals.

7. The method of claim 6 wherein determining whether a claim is classified as high risk includes asking an injured employee a plurality of questions.

8. The method of claim 6 wherein determining whether a claim is classified as high risk includes asking an employer a plurality of questions.

9. The method of claim 6 wherein determining whether a claim is classified as high risk includes asking a medical professional treating the injured employee a plurality of questions.

10. The method of claim 7 wherein the plurality of questions are selected from the group consisting of: education level; job title; job description; date of injury; date reported to supervisor/employers; ask questions about the incident that caused the injury; what happened, when, how, where; anyone else involved; anyone witness the incident; describe your injury; do you think you could have prevented the incident from happening; what medical treatment did you receive, by who, when; when is your next appointment; do you have any physical restrictions; are you currently taking any type of medication, if yes, what; did you ever have any problems with your body part before, if yes—try to find out what, how, when; have you ever had any other work related injuries; how are you feeling now; are you comfortable with your primary medical provider; do you have any allergies; have you ever had any surgeries, serious illness, what, when, why; do you consider yourself to be normally healthy; how are your eating habits; do you have any hobbies; what do you do for recreation; do you smoke, how long, how much; do you drink, how much; do you get along well with the people at work; are you looking forward to returning to work; do you have any questions or concerns regarding your claim, or combinations thereof.

11. The method of claim 8 wherein the plurality of questions are selected from the group consisting of: what is name of person you are talking with, date and time; employees name, date of hire; job title; job description, including responsibilities and physical requirements; home address, telephone number; description of injury, was employee sent directly to primary medical provider, If yes who; results of primary medical provider's evaluation, diagnosis, restrictions, if known, treatment plan, prognosis, Is employee currently back to work, what job; If employee is not working, why not, restrictions unable to be met; what type of employee has he been during the past; attitude/relationship with supervisor, management, co-workers, attendance pattern; any recent disciplinary problems, If yes, what; and combinations thereof.

12. The method of claim 9 wherein the plurality of questions are selected from the group consisting of: when did you first see employee, diagnosis, prognosis, what is your current treatment plan for employee, when did you last see employee, considering the description of the accident/incident, do you believe the medical condition is the result of the incident, or combinations thereof.

13. The method of claim 7 further including the steps of:
implementing best practices into the workers' compensation claims management process;
monitoring the amended workers compensation claims management process to determine if the best practices are being followed; and
closely monitoring a specific case within the workers' compensation claims management process to determine if the best practices are not being followed.

14. The method of claim 10 further including the steps of:
implementing best practices into the workers' compensation claims management process;
monitoring the amended workers compensation claims management process to determine if the best practices are being followed; and
closely monitoring a specific case within the workers' compensation claims management process to determine if the best practices are not being followed.

15. The method of claim 7 further comprising the step of closely monitoring a specific case within the workers' compensation claims management process to determine if the best practices are not being followed if the claim is classified as a high risk.

16. The method of claim 10 further comprising the step of closely monitoring a specific case within the workers' compensation claims management process to determine if the best practices are not being followed if the claim is classified as a high risk.

17. The method of claim 11 further comprising the step of closely monitoring a specific case within the workers' compensation claims management process to determine if the best practices are not being followed if the claim is classified as a high risk.
